(19) United States
(12) Patent Application Publication
(10) Pub. No.: US 2009/0132545 A1
(43) Pub. Date: May 21, 2009

(54) Contents management system

(76) Inventors: Hiroshi Kurihara, Kawasaki (JP); Yoshitaka Iwata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/230,463

(22) Filed: Aug. 29, 2008

(30) Foreign Application Priority Data
Nov. 20, 2007 (JP) 2007-299983

(51) Int. Cl. G06F 17/30

(52) U.S. Cl. 707/10

(57) ABSTRACT

A contents management system provides a user who already downloaded valid contents with a mechanism capable of downloading the same contents in a duplication manner. A system for delivering contents checks whether contents which are about to be purchased by the user are the same as contents which are in a validity term and which are already downloaded by the user. If so, the system prepares a new contents ID, DL information and meta information for duplicated buying, and makes duplicated buying of the same contents possible.

### INCORPORATION BY REFERENCE

The present application claims priority from Japanese application JP 2007-299983 filed on Nov. 20, 2007, the content of which is hereby incorporated by reference into this application.

### BACKGROUND OF THE INVENTION

The present invention relates to a technique for downloading contents stored in a storage device to a user in response to a request from the user.

Forms for providing contents watched or listened to by users via a communication network are broadly classified into streaming and downloading. One of known techniques for downloading contents stored in a storage device and watching or listening to the contents is described in JP-A-2002-34059.

Intra-airplane entertainment system apparatus have become developed and provided to remotely meet passengers' desire to enjoy contents such as music or videos when seated on airplane seats. It is becoming possible to selectively watch or listen to a large number of contents such as, for example, movie contents in the range of 50 to 200 titles by using a high efficiency image compression technique such as MPEG 1/2.

A configuration of a conventional intra-airplane entertainment system is shown in FIG. 12 in JP-A-2002-34059. In FIG. 12, a program video service control unit 121, a video server 122, a distributor/coupler 123, distributors 124 to 126, seat terminals 127 to 129, and liquid crystal displays 130 to 132 are shown.

Video signals compressed by using the MPEG2 scheme or the like are recorded in the video server 122. Upon receiving a request from each seat terminal, the program video service control unit 121 reads out data compressed by using the MPEG2 scheme and recorded from the video server 122 and distributes contents to respective seat terminals. The contents are distributed via the distributor/coupler 123 and the distributor 124, 125 or 126. The contents are modulated by using a modulation scheme such as 16QAM and transmitted in a transport stream form of MPEG2 via a coaxial cable or the like.

At this time, communication between the program video service control unit 121 and the seat terminals 127, 128 and 129 is conducted by using the TCP/IP protocol. The signal of TCP/IP protocol is also subjected to frequency modulation, and its communication is conducted via the same coaxial cable as the contents delivery. Therefore, the distributor/coupler 123 has frequency multiplexing and demultiplexing functions with respect to the MPEG2 transport stream and the TCP/IP signal. The distributors 124, 125 and 126 conduct signal branching and distribute the same signals to respective seat terminals. The seat terminals 127, 128 and 129 conduct MPEG2 compression and expansion on compressed and transmitted video and audio signals, and conduct display on the liquid crystal displays

The above-described system is typically called video on demand system (VOD system). The intra-airplane entertainment system described in JP-A-2002-34059 is used in an airplane which is a closed network environment and restricted to delivery of videos to fixed users of respective seat terminals. Therefore, user authentication, terminal authentication, license authentication on delivered video, and encryption of the delivered video are not considered. In the current VOD service using a VOD system implemented in cable TV and digital TV, it is general to conduct the user authentication, terminal authentication, license authentication on a video to be delivered, and encryption of the video to be delivered to implement video delivery on demand from an unspecific user.

In the VOD service, the user selects video contents that the user wants to watch, and thereafter delivery of video is conducted in real time and the user watches the video on the spot. While video is being received in the VOD service, however, a large amount of video information flows through the network. During that time, the network load is increased extremely. Furthermore, the real time property is needed extremely in transmission of video information, and the priority of video information transmission becomes high. If it is attempted to conduct other information processing using the network in parallel, therefore, not only the processing speed of other information processing becomes slow, but also other information processing might be obstructed.

In service under study, therefore, a user requests downloading of video information on a terminal and the video information is downloaded to the terminal and stored in the terminal while the network is not used, and the user watches the stored video information at timing desired by the user. This is called DL service. In the DL service, video information is downloaded to the terminal and stored beforehand and the network is not used while the user is watching the video information, and consequently the problem that the network load is increased does not occur. Furthermore, video information downloaded once can be watched on the terminal many times in a time period over which the video information can be viewed and listened to. This is similar to the fact that a rental video rent from a rental video shop can be watched many times during its rental time period. In recent years, the advance of terminals is extreme, and any of a fixed terminal such as TV or a desktop PC and a mobile terminal such as a portable telephone, a PDA or a mobile PC can be connected to the Internet. The same information can be accessed from any terminal. Therefore, it becomes possible for the user to select a video that the user wants to watch on the next day from a video list by using, for example, portable telephone, request DL service from a portable terminal beforehand, and watch the video desired by the user and downloaded to TV in the user's home beforehand, at desired timing on the next day after the user's returning home.

Such convenience of the user cannot be obtained in the VOD service by any possibility. In other words, it can be said that the DL service is information providing service which can cope with flexibly the user's circumstances and which is highly convenient to the user in the mobile information society. As a matter of course, in the DL service as well, it is general to conduct the user authentication, terminal authentication, license authentication on delivered video, and encryption of the delivered video to implement the DL service of video to an unspecific user.

### SUMMARY OF THE INVENTION

First, information for a center system to typically provide and manage DL service, mainly relations between keys and contents in the conventional DL service will now be described with reference to FIG. 10. Usually, contents 1003 downloaded to a user's terminal themselves are encrypted by using a corresponding encryption key 1002. The reason will now be described. In the DL service, contents 1003 encrypted by using a corresponding encryption key 1002 are downloaded to a user's terminal. When thereafter the user watches or listens to the downloaded contents 1003 at desired timing, the user's terminal acquires the corresponding encryption key 1002 from the center system, decrypts the contents 1003 encrypted by using the encryption key 1002, by using the encryption key 1002 on the user's terminal, and watches or listens to the contents 1003. That is the reason. Elementary contents identification information 1001 for providing and managing the DL service is provided so as to be associated with the encryption key 1002 and the contents 1003.

The elementary contents identification information 1001 includes information of a contents name (title of contents themselves, such as, for example, MH, O3 or O2 in FIG. 10), an encryption key (for example, Key A, Key B or Key C in FIG. 10), a license condition (for example, export permitted/not permitted, and 18 or less years old forbidden to watch or listen to/15 or less years old forbidden to watch or listen to), a user ID, date of sale, and a watching or listening time period as sale information, a DL contents providing place, a license (encryption key) providing place, a meta information (such as a brief introduction of a language, a genre, a program advertisement and a title accompanying the contents themselves, and performers) providing place as DL information for actually executing the DL of the contents and the encryption key, and a brief introduction of a language, a genre, a program advertisement and a title accompanying the contents themselves and performers as meta information. In addition, those kinds of information are provided with one identifier referred to as contents ID (CNT 1234, CNT 1201 and CNT 1301 in FIG. 10). The contents ID is used as an identifier in the provision and management of the DL service.

In the conventional DL service, the user ID, the sale date and the watching or listening time period are managed in one body as the elementary contents identification information 1001 by using the contents ID as heretofore described. While a certain user is utilizing the DL service with respect to certain contents (over a watching or listening time period), therefore, the user cannot download the contents again. In other words, in the case where the user downloads contents in the past and retains the contents which are valid at the present time as well, the user might attempt to purchase the contents anew. However, attention is not paid to elementary contents information needed to purchase the contents and the encryption key 1002 needed to watch or listen to the contents at all.

A service image of the DL service and importance and necessity of duplicated buying situation will now be described with reference to FIG. 13. FIG. 13(a) shows an example of DL service in which duplicated buying cannot be conducted. In this case, the user requests first DL service on the night of November 19 as a first DL. For example, DL service of three days and two nights is requested with respect to a title MH. Reference numeral 1301 denotes a time period over which the user can watch or listen to after contents were actually downloaded. Until November 21, the user can watch or listen to the downloaded contents. Supposing a movie in the range of two to three hours with respect to the capacity of contents, it takes a nearly equal time to download the movie although it depends upon the network traffic as well. Depending upon the commodity plan of the terminal, therefore, it is sufficiently considerable to download contents in a midnight time zone in which the user is not using the terminal and the traffic is also low. Depending upon the commodity plan of the terminal in the same way, reproduction can be conducted after downloading is completed in some terminals or according to basic terminal specifications. Therefore, a user having such a basic terminal can watch or listen to after downloading is completed. As for terminals, terminals having a mechanism of progressive downloading are also conceivable (Progressive downloading means that contents can be reproduced, watched or listened to while the contents are being downloaded.). All terminals put on the market are not always such high function terminals.

It is now supposed that the user makes a sudden remote business trip and returns home from the business trip on November 22 or later as shown in FIG. 13. In this case, the user cannot watch or listen to contents downloaded in 1301 on purpose. Even if the user returns home on November 22 and requests DL service again immediately, it is considered that it takes a time to conduct downloading as described above. This might result in a problem that the user cannot watch or listen to the contents immediately. The user returns home on November 22, and immediately requests DL service in which the term of validity is that day with respect to a title MH again. Thereafter, contents are actually downloaded. Reference numeral 1302 denotes a time period over which the contents can be watched or listened to.

On the other hand, FIG. 13(b) shows an example of DL service in the case where the user is permitted to conduct duplicated buying. In this case, DL service is requested again as re-DL on November 20 at timing when a remote business trip is determined on November 20. For example, the user requests DL service of three days and two nights with respect to the title MH. Reference numeral 1303 denotes a time period over which the user can watch or listen to after contents were actually downloaded. Until November 22, the user can watch or listen to the downloaded contents. In this way, at timing when it is determined that the user cannot watch or listen to contents with respect to which the DL service is already requested, within a time period over which the user can watch or listen to the contents, an opportunity of executing the re-DL is provided. As a result, opportunities for the user to watch or listen to are increased, and troublesomeness of waiting downloading in the DL service is mitigated. In addition, it becomes possible to provide a DL service which can cope with flexibly the user's circumstances and which is highly convenient to the user.

Another example will also be described. A child downloads contents under the condition that the contents should be returned on the same day as that of rental (a day rental). However, a relative is hospitalized suddenly and it is found that all family members will go out from now on. It is desired to conduct re-DL of four days and three nights before going to the hospital so with respect to be capable of watching or listening to the contents immediately after returning home. In the case where duplicated buying cannot be conducted, however, such a request cannot be coped with. Therefore, the day rental passes the fixed term, and re-DL cannot be conducted until after returning home. The re-DL must be waited until tomorrow. In the case of DL service which permits duplicated buying, however, the child can conduct re-DL of four days and three nights before going to the hospital and watch or listen to contents already downloaded, immediately after returning home. In the case of TV, the concept of one set per person is not present in general. If it is typical that all family members utilize the TV, then it is conceivable that a different family member purchases the same contents without knowing that some family member purchases them. Therefore, it is necessary that the user normally judges whether the duplicated buying is conducted truly out of necessity or the duplicated buying is conducted by mistake and a needing user is provided with the opportunity of duplicated buying. The problem that the user must be supported in judging whether the duplicated buying is conducted truly out of necessity or the duplicated buying is conducted by mistake when providing DL service which permits duplicated buying as described above is also important.

In order to solve the problems, in accordance with the present invention, a center system which has received a contents download request from a user judges whether the user already downloaded the same contents which can be watched or listened. If such contents are already downloaded, the center system generates a contents ID, DL information and meta information of the contents anew as information for duplicated buying. As a result, it is possible for the user to conduct duplicated buying of the same contents which can be watched or listened. The center system has functions and means for implementing the operation.

Owing to the DL service permitting duplicated buying as described above, it becomes possible to provide DL service which increases the opportunities of the user to watch or listen, which reduces the troublesomeness of download waiting in the DL service, which is capable of flexibly cope with the user's circumstances, and which is highly convenient to the user.

Other objects, features and advantages of the invention will become apparent from the following description of the embodiments of the invention taken in conjunction with the accompanying drawings.

### BRIEF DESCRIPTION OF THE DRAWINGS

FIG. 1 shows an embodiment of a network configuration;

FIG. 2 shows a configuration example of a center system and a user terminal;

FIG. 3 shows a configuration example of function units concerning sale acceptance to DL information provision;

FIGS. 4A to 4C show an embodiment of sale management information and so on;

FIGS. 5A and 5B show an embodiment of DL information;

FIGS. 6A and 6B show an embodiment of meta information;

FIG. 7 shows an embodiment of information stored in a DL information providing place DB;

FIG. 8 shows an embodiment of a flow of processing conducted when the center system has accepted a contents purchase request from a user;

FIG. 9 shows an embodiment in the case where the center system is formed of servers and DBs;

FIG. 10 is a diagram showing relations between keys and contents in conventional service;

FIG. 11 is a diagram showing relations between keys and contents in service according to the present embodiment;

FIG. 12 shows an embodiment of a screen displayed on a user terminal when duplicated buying is conducted; and

FIG. 13 is a diagram showing a situation of execution permitted to the user when conducting duplicated buying.

### DESCRIPTION OF THE EMBODIMENTS

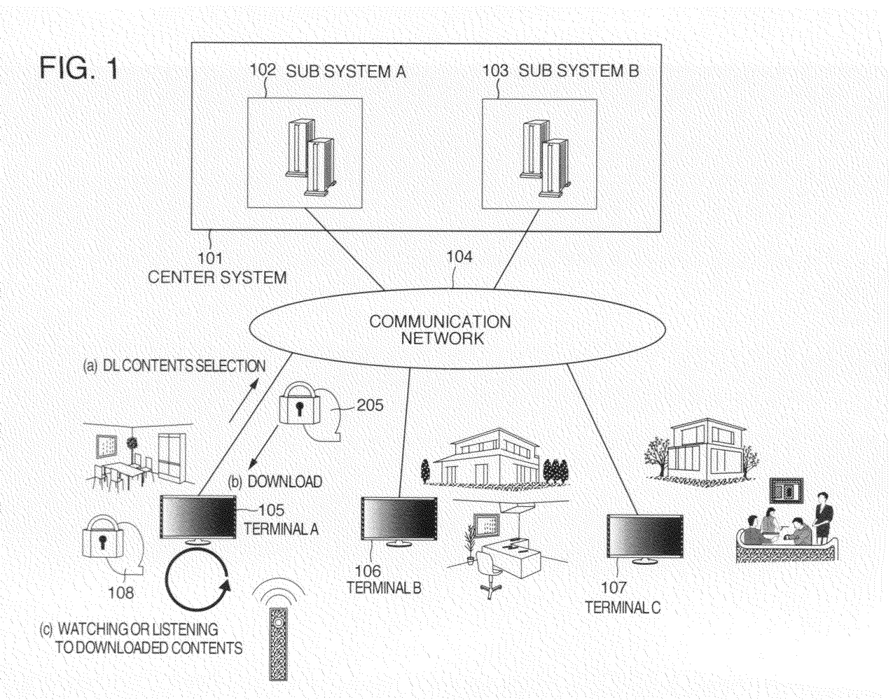

Hereafter, one of embodiments according to the present invention will be described with reference to the drawings. FIG. 1 shows an embodiment of a network configuration in the present invention. For example, user terminals 105, 106 and 107 such as a PC, a TV or a PDA are connected to a center system 101 which controls delivery of contents via, for example, a communication network 104 such as the Internet. The center system 101 receives a delivery request of contents from the user terminal 105 or the like via the communication network 104. If the center system 101 judges the delivery to be possible, then the center system 101 downloads the contents to the user terminal 105 or the like via the communication network 104. The center system 101 may be suitably divided into a plurality of subsystems 102 and 103 according to the function or the requested processing capability. It is not always necessary to form the center system 101 of one apparatus. Furthermore, the subsystems 102 and 103 may be located on different networks at a geographical distance.

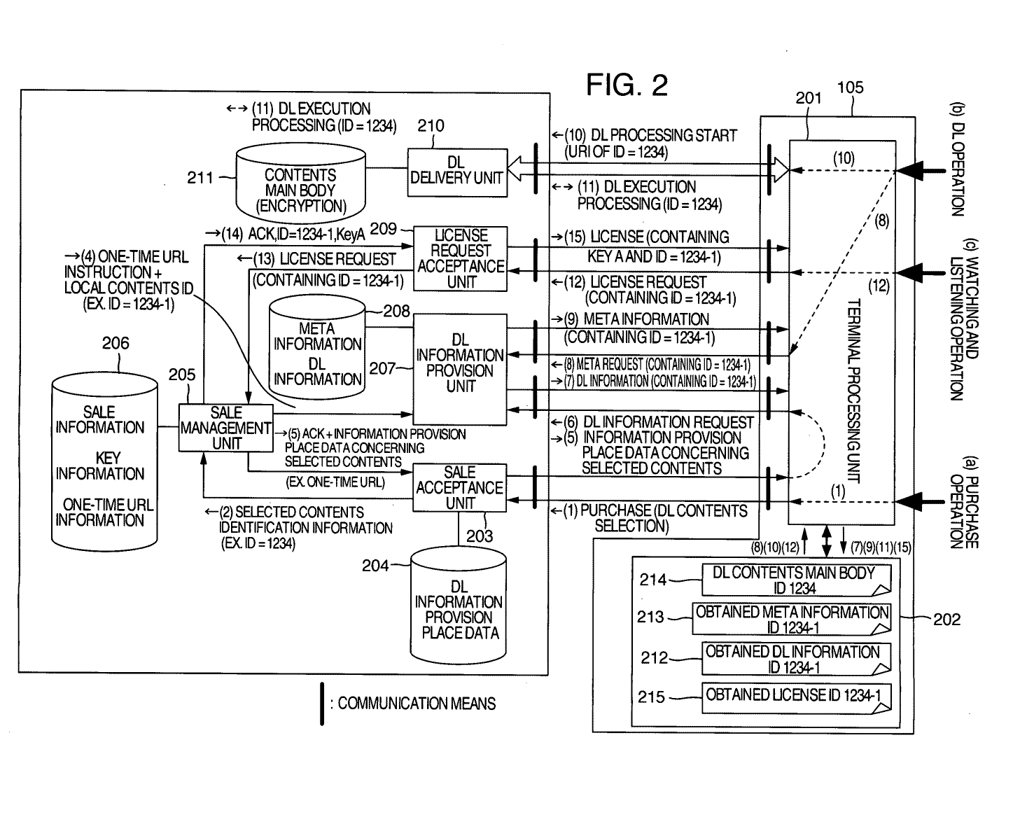

FIG. 2 is a diagram for exemplifying the center system 101 and the user terminal 105 and explaining an embodiment of function units included in the center system 101 and the user terminal 105. The user terminal 105 includes a terminal processing unit 201 for transmitting information to the center system 101 in response to user's operation, or conducting processing on information received from the center system 101 and conveying resultant information to the user as occasion demands, and a storage unit 202 for storing information transmitted to and received from the center system 101.

The center system 101 includes a sale acceptance unit 203 for accepting a download request of contents from the user, a sale management unit 205 for managing what sort of contents the user is downloading, a DL information provision unit 207 for generating download information which is information required for the user to download contents and providing the user with the download information, and a DL delivery unit 210 for conducting processing of delivering contents main body to the user when the user downloads the contents main body by using download information acquired from the DL information provision unit 207. The center system 101 includes a storage unit 204 for storing a place where the download information is provided, such as, for example, a URL every contents, a storage unit 206 for storing contents sale information of every user, key information required to reproduce contents, and a temporarily used URL or the like which is a place where download information of contents is provided when the user conducts duplicated buying of contents, a storage unit 208 for storing meta information and DL information of contents, and a storage unit 211 for storing contents main body.

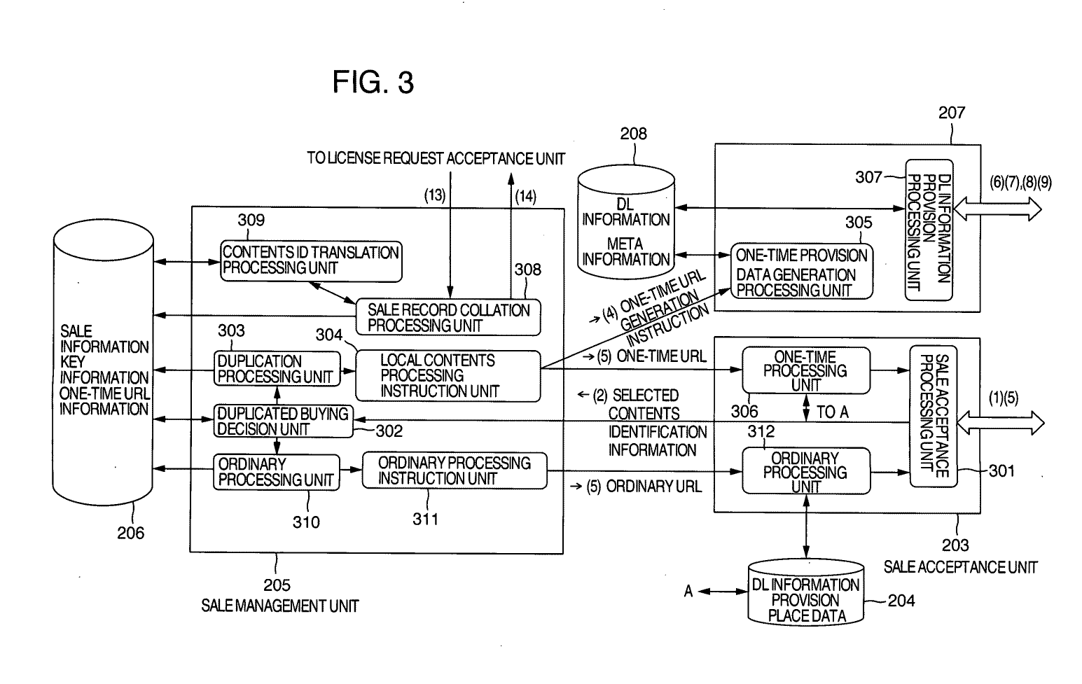

FIG. 3 is a diagram for explaining a more detailed embodiment with respect to the sale acceptance unit 203, the sale management unit 205 and the DL information provision unit 207 in the center system 101. Hereafter, a series of processing in which the user terminal 105 downloads contents will be described with reference to FIGS. 2 and 3.

The center system 101 provides the user terminal 105 with a list of contents. The user selects desired contents from among contents displayed on a display screen of the user terminal 105. If the user executes a purchase operation such as clicking contents on the display screen, then the terminal processing unit 201 in the user terminal 105 transmits a message to the center system 101 to request purchase of contents.

Upon receiving the contents purchase requesting message from the user terminal 105, the sale acceptance unit 203 in the center system 101 discriminates contents ID which is information for identifying contents requested by the user, user information, and validity term information of the contents desired by the user, by using a sale acceptance processing unit 301. It is supposed in this embodiment that the contents ID is, for example, “1234,” the user ID is, for example, “1101,” and the validity term information is three days and two nights. The sale acceptance processing unit 301 transmits the contents ID “1234” to the sale management unit 205. A duplicated buying decision unit 302 in the sale management unit 205 checks whether the user has a right to normally watch or listen to contents identified by the contents ID “1234” at the present time by referring to sale information in the storage unit 206. In this way, the sale management unit 205 judges whether the user attempts to conduct duplicated buying of contents having the same contents although the user has contents which can be executed and which are already downloaded.

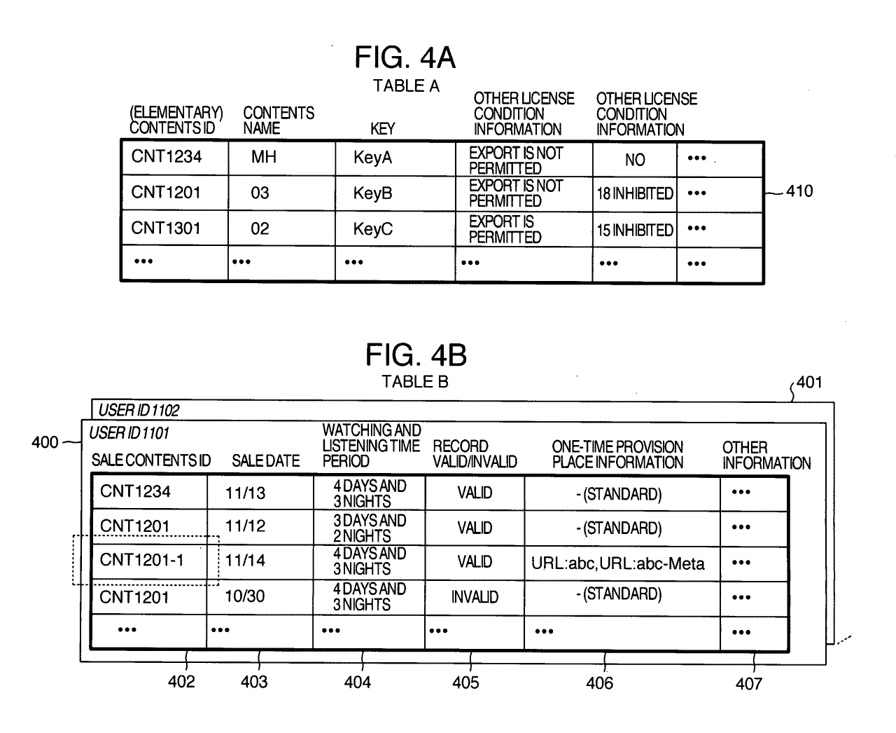

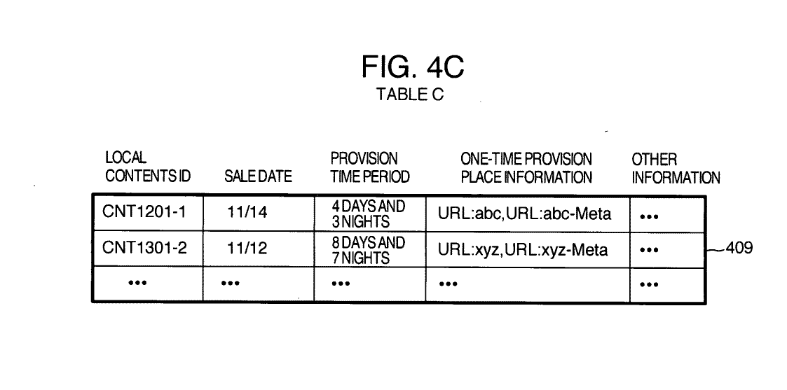

An embodiment of information stored in the storage unit 206 is shown in FIGS. 4A to 4C. In the embodiment shown in FIGS. 4A to 4C, sale information 400 and 401 of every user, key information 410, and one time URL 409 are stored in the storage unit 206. With respect to sale information, a table of sale information 400 is prepared for a user having a user ID 1101 and a table of sale information 401 is prepared for a user having a user ID 1102. Each table has columns of contents ID 402 for identifying contents, a sale date 403 which is date of contents sale, a watching or listening time period 404 which represents a time period over which the contents can be watched or listened to, a record valid/invalid flag 405 which indicates whether a record of the contents is valid on the basis of whether the current date is within the watching or listening time period from the sale date of the contents, place information 406 of a URL or the like which specifies a place where information required to download the contents is available, and other information 407. In the present embodiment, the URL is exemplified as the place information. However, it is also possible to use address information such as an IP address other than the URL or information by which a location on the network can be specified, as the place information.

In FIG. 4B, contents IDs “1201” and “1201-1” represent that duplicated buying has occurred. The reason why the provision place information 406 of the contents ID “1201” is “standard” is that a provision place originally prepared for contents having the contents ID “1201” can be used. On the other hand, the reason why the provision place information 406 of the content ID “1201-1” is “URL:abc” is that the DL information provision unit 207 described later temporarily generates a provision place for duplicated buying.

Since the contents ID “1234” is already registered in the sale information table 400 and the entry is valid in the watching or listening time period, the duplicated buying decision unit 302 judges that the user is attempting to conduct duplicated buying of the same contents. In this case, a duplication processing unit 303 generates a new contents ID “1234-1”, generates a one-time URL to be used to download contents by using the new contents ID, and registers the contents ID “1234-1” and the generated one-time URL in the sale information table 400 as the provision place information 406.

Both contents IDs “1234” and “1234-1” are identification information which indicates the same contents. Since download processes are different, however, different identifiers are provided although the contents are the same. And the present embodiment has a feature that DL information and meta information are generated for each of the contents IDs “1234” and “1234-1” which indicate the same contents.

And a local contents processing instruction unit 304 gives notice of the contents ID “1234-1” and the one-time URL, and the elementary contents “1234” and the provision term of contents to a one-time provision data generation processing unit 305 in the DL information provision unit 207, and instructs the one-time provision data generation processing unit 305 to generate DL information and meta information by using the ID and URL to cause the user to download contents. By the way, the user does not always request acquisition of meta information. Therefore, generation of the meta information is not indispensable, but may be omitted.

The DL information includes information required to specify contents with the contents ID “1234-1” and download the contents, such as, for example, a URL or the like which is a provision place of the meta information, a place of a URL or the like to which contents themselves are to be downloaded, and a provision place of a license for executing the downloaded contents. As for the DL information, a tag language described in, for example, RFC 4287 may be utilized.

The meta information is information which indicates an attribute of contents identified by the contents ID “1234-1” and downloaded. For example, if the contents are a movie, the meta information includes information of its genre and language. In addition, the meta information includes information concerning the user and term of validity of downloading and information of a condition concerning the utilization license of the user (for example, right of watching or listening). This meta information is a data group serving as a source of description language type meta data which is standardized in, for example, ARIB (Association of Radio Industries and Businesses) STD-B38 with respect to writing rules. The one-time provision data generation processing unit 305 stores the generated DL information and meta information in the storage unit 208.

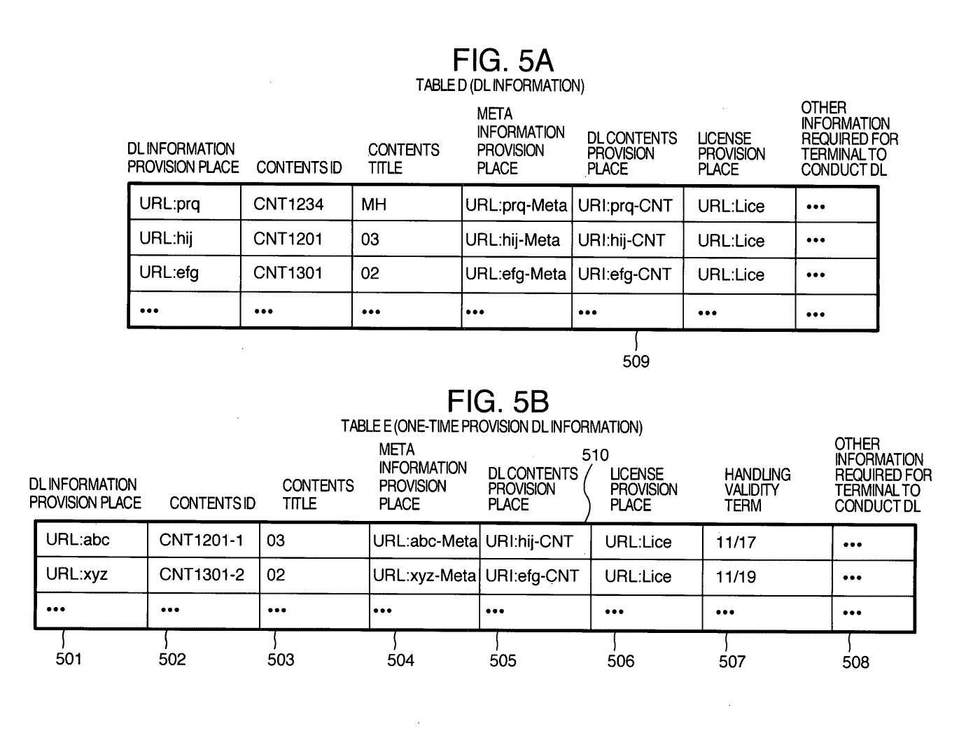

An embodiment of the DL information is shown in FIGS. 5A and 5B. DL information 509 is DL information in the case where duplicated buying is not conducted and contents are specified by an elementary contents ID. DL information 510 is DL information in the case where contents are specified by a contents ID which is generated anew on the basis of an elementary contents ID because of duplicated buying. The DL information 510 includes a DL information provision place 501 which indicates a place where DL information can be acquired, a contents ID 502, a contents title 503 such as, for example, a movie title, a meta information provision place 504 which indicates a place where meta information can be acquired when downloading using a contents ID for duplicated buying, a DL contents provision place 505 which is a place for downloading contents main body, a license provision place 506 which is a place for acquiring a license to execute the contents, a handling term 507 which indicates the term of validity of contents subjected to duplicated buying, and other information 508.

Comparing the DL information 509 with the DL information 510, the original contents ID and the contents ID for duplicated buying have a feature in that they are different in the DL information provision place 501 and the meta information provision place 504 and they are the same in the DL contents provision place 505 and the license provision place 506. In other words, by preparing the DL information provision place 501 and the meta information provision place 504 every contents ID, a plurality of data needed to acquire contents are prepared. By making the DL contents provision place 505 the same, one contents main body suffices. By making the license provision place 506 the same, one suffices for the contents reproduction key as well.

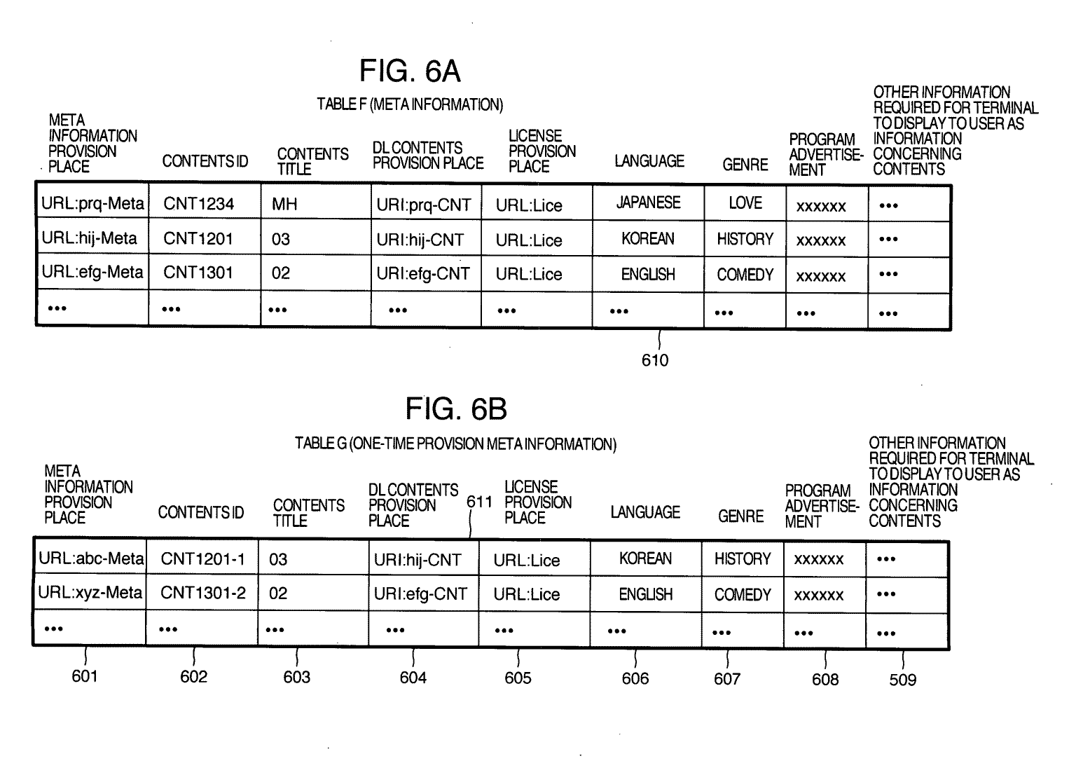

An embodiment of meta information is shown in FIGS. 6A and 6B. In FIGS. 6A and 6B, meta information 610 is a table storing information accompanying contents which are not a subject of duplicated buying and which are specified by the original contents ID, whereas meta information 611 is a table storing information accompanying contents which are a subject of duplicated buying and which are specified by contents ID generated by the duplication processing unit 303. In the meta information 611, a meta information provision place 601 which represents place information such as a URL or the like where meta information can be acquired, a contents ID 602, a contents title 603, a DL contents provision place 604, a license provision place 605, a language 606 used in the contents, a genre 607 of the contents, a program advertisement 608 which is advertisement information, and other information 609 provided to the user are stored.

Comparing the table of the meta information 610 with the table of the meta information 611, the original contents ID and the contents ID for duplicated buying are different in the meta information provision place 601, and are the same in the DL contents provision place 604 and the license provision place 605.

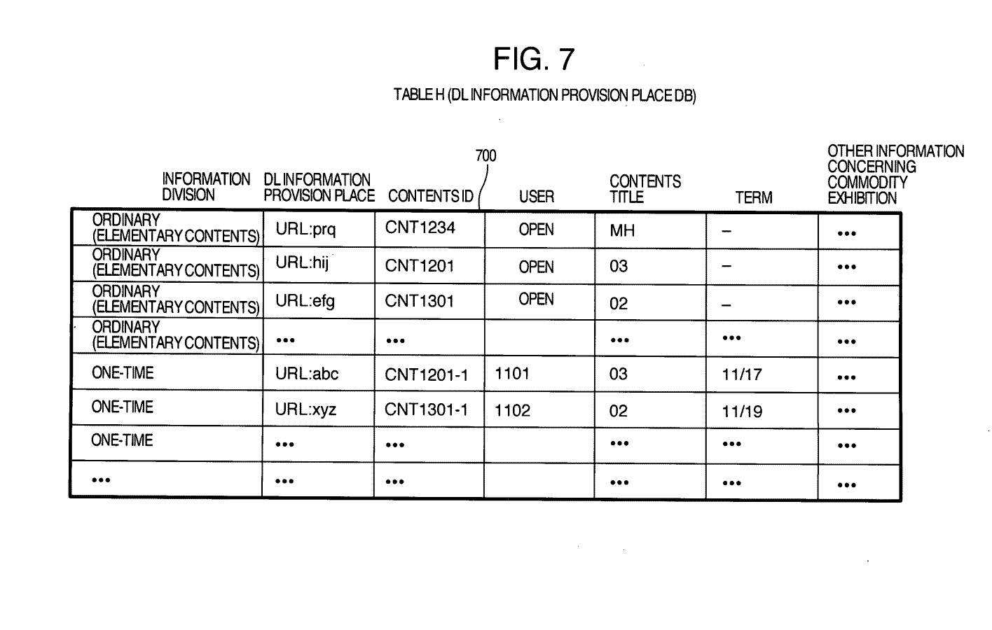

The local contents processing instruction unit 304 gives notice of ACK which conveys acceptance of user's duplicated buying and a one-time URL generated for a contents ID “1234-1” to a one-time processing unit 306 in the sale acceptance unit 203. The one-time processing unit 306 stores the one-time URL in the storage unit 204 as DL information provision place data. An embodiment of DL information provision place data is shown in FIG. 7. As shown in this embodiment, DL information provision place data 700 is information obtained by associating at least the contents ID and the DL information provision place with each other.

And the sale acceptance processing unit 301 transmits a message which conveys that purchase of contents has been accepted and a one-time URL which needs to be accessed to download the contents to the user. Thereafter, the one-time URL is displayed on the display screen of the user terminal 105. If the user clicks the one-time URL or the user terminal 105 automatically accesses the one-time URL, the terminal processing unit 201 transmits a message to the center system 101 to request DL information.

By the way, the center system 101 may transmit a message for informing that the user is attempting to conduct duplicated buying of contents which can be watched or listened by the user, and a message for ascertaining the user's intention to determine whether the user wants to purchase nevertheless to the user terminal 105. When the user responds to this message by returning an intention to conduct duplicated buying nevertheless, the center system 101 may transmit a notice that the purchase is accepted and a one-time URL to the user terminal 105. In this case, it is possible to cause the user who is about to purchase the same contents without intention and by mistake to take care.

Upon receiving the message, a DL information provision processing unit 307 in the DL information provision unit 207 refers to the storage unit 208, acquires DL information in the case where contents are specified with the contents ID “1234-1,” and returns the DL information to the user terminal 105. The DL information includes information required to specify contents with the contents ID “1234-1” and download the contents, such as, for example, a URL or the like which is a provision place of the meta information, a place of a URL or the like to which contents themselves are to be downloaded, and a provision place of a license for executing the downloaded contents. The user terminal 105 stores the received DL information in the storage unit 202 as obtained DL information 212.

Subsequently, the user terminal 105 requests meta information from a meta information provision place contained in the received DL information 212 by using the contents ID “1234-1” contained in the DL information 212. Upon receiving the request of the meta information, the DL information provision processing unit 307 in the DL information provision unit 207 refers to the storage unit 208, acquires meta information corresponding to a provision place of meta information accessed by the user, and returns the meta information to the user terminal 105. In other words, the DL information provision processing unit 307 refers to the Table G shown in FIG. 6B, and provides the user with meta information of an entry corresponding to the meta information provision place used by the user.

The terminal processing unit 201 stores provided meta information in the storage unit 202 as obtained meta information 213. By the way, since the acquisition of the meta information is not processing which is indispensable to the user terminal 105 in downloading contents, it may be omitted.

Subsequently, the user terminal 105 requests downloading of contents main body by using DL contents provision place information contained in the obtained DL information 212 or the obtained meta information 213. The DL delivery unit 210 in the center system 101 acquires contents corresponding to the place information such as a URL used in the request, from the storage unit 211, and causes the contents to be downloaded to the user terminal 105. The user terminal 105 stores the downloaded contents main body in the storage unit 202 as a DL contents main body 214. The DL contents provision place information for requesting downloading of the contents main body becomes the same place information, if the contents are the same. In other words, since the contents IDs “1234” and “1234-1” indicate the same contents, the DL contents provision place information also becomes the same information such as a URL. Even in the case where duplicated buying of contents is conducted, therefore, it becomes unnecessary to prepare a plurality of combinations of contents main body and encryption key beforehand.

Finally, the user terminal 105 requests a license for executing contents by using license provision place information contained in the obtained DL information 212 or the obtained meta information 213. A license request acceptance unit 209 in the center system 101 inquires of the sale management unit 205 about acquisition of a license of contents corresponding to a contents identifier used in the request. A sale record collation processing unit 308 in the sale management unit 205 refers to sale information of the pertinent user stored in the storage unit 206, and judges whether a license is given to the user. This decision is made by, for example, using conditions such as whether a record is valid and whether the number of times of execution permitted to the user is not exceeded.

Upon judging that license is possible, the sale record collation processing unit 308 transmits the contents ID “1234-1” contained in the license request to a contents ID translation processing unit 309. The contents ID translation processing unit 309 translates the contents ID “1234-1” to the original contents ID “1234,” refers to key information stored in the storage unit 206 and shown in Table A in FIG. 4A, acquires an encryption key “Key A” corresponding to the contents ID “1234,” and delivers the encryption key “Key A” to the sale record collation processing unit 308. The sale record collation processing unit 308 transmits the encryption key to the license request acceptance unit 209. Upon receiving the encryption key, the license request acceptance unit 209 transmits the encryption key to the user terminal 105. The user terminal 105 stores the encryption key in the storage unit 202 as an obtained license 215.

In the same way as the DL contents provision place information, the license provision place information also indicates the same place if the contents are the same. For the contents IDs “1234” and “1234-1,” therefore, the license provision place information also becomes the same place information such as a URL. Even in the case where duplicated buying of contents is conducted, therefore, it becomes unnecessary to prepare a plurality of encryption keys for one contents beforehand.

Upon finishing the operation heretofore described, the user terminal can execute the acquired contents by using the encryption key. For example, the user terminal can reproduce and utilize a moving picture.

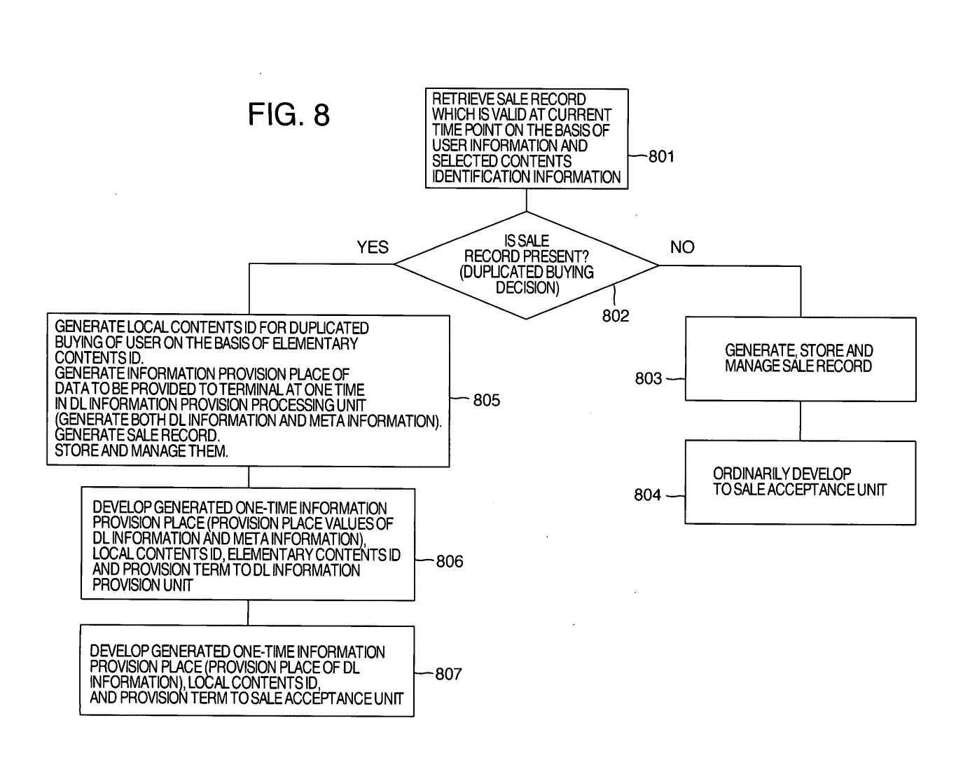

FIG. 8 shows an embodiment of a flow of processing conducted when the center system has received a sale request of contents from the user terminal 105. First, the duplicated buying decision unit 302 refers to sale information of the pertinent user in the storage unit 206 by using user information or the contents ID contained in the sale request (801), and ascertain with respect to the user whether a sale record of contents which are specified by the contents ID and which can be watched or listened to is stored (802). If the sale record is not present, then the purchase is not duplicated buying and consequently an ordinary processing unit 310 in the sale management unit 205 generates a new sale record (803), and instructs an ordinary processing unit 312 in the sale acceptance unit 203 via an ordinary processing instruction unit 311 to transmit a menu of ordinary contents sale processing for a purchase which is not duplicated buying to the user terminal 105 (804).

If the purchase is duplicated buying, the duplication processing unit 303 stores a new contents ID for duplicated buying and a provision place of generated DL information in a sale record in the storage unit 206 respectively as the sale contents ID 402 and the one-time provision place information 406 (805). The local contents processing instruction unit 304 instructs the one-time provision data generation processing unit 305 to generate DL information and meta information. The one-time provision data generation processing unit 305 generates the DL information and the meta information, and stores them in the storage unit 208 (806). The local contents processing instruction unit 304 notifies the sale acceptance processing unit 301 of the generated one-time provision place information (807). The sale acceptance processing unit 301 further develops the one-time provision place information into the user terminal.

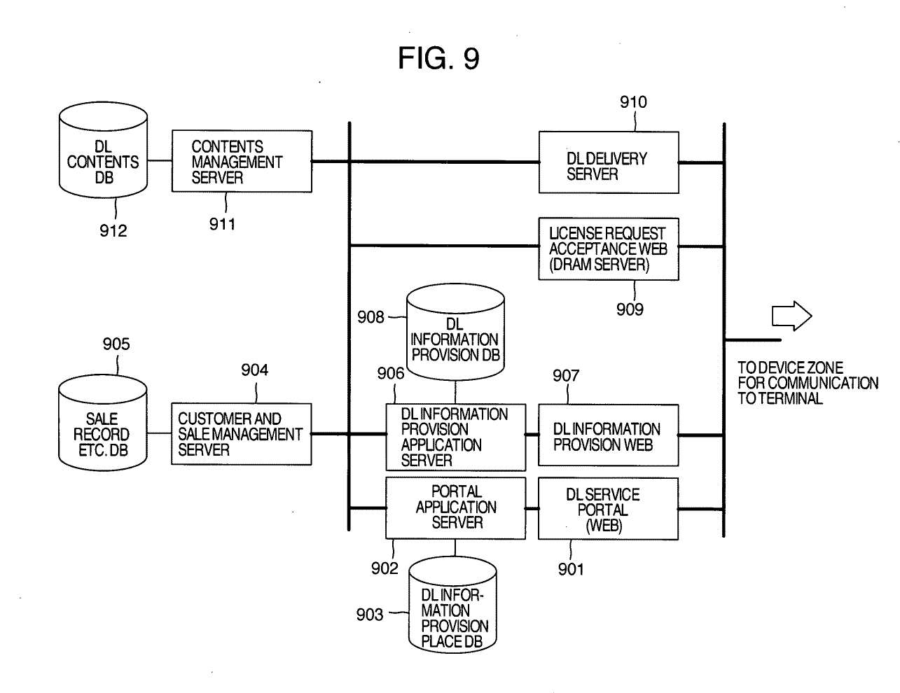

FIG. 9 shows a configuration example in the case where function units of the center system shown in FIG. 2 are formed of server apparatuses. In FIG. 9, the sale acceptance unit 203 is implemented by using a DL service portal 901 and a portal application server 902, and the storage unit 204 is implemented by using a DL information provision place DB 903. The sale management unit 205 is implemented by using a customer & sale management server 904, and the storage unit 206 is implemented by using a sale record etc. DB 905. The DL information provision unit 207 is implemented by using a DL information provision application server 906 and a DL information provision web 907, and the storage unit 208 is implemented by using a DL information provision DB 908. The license request acceptance unit 209 is implemented by using a license request acceptance web 909, and the DL delivery unit 210 is implemented by using a DL delivery server 910 and a contents management server 911. The storage unit 211 is implemented by using a DL contents DB 912. This is nothing but one configuration example. Function units shown in FIG. 2 by using arbitrary information processing apparatuses such as servers and computers and dividing or combining functions freely as occasion demands. For example, the function units shown in FIG. 2 and FIG. 3 may be implemented as respective different apparatuses. If the processing capability of the computer is improved in the future, the center system 101 might be implemented by using one apparatus in some cases.

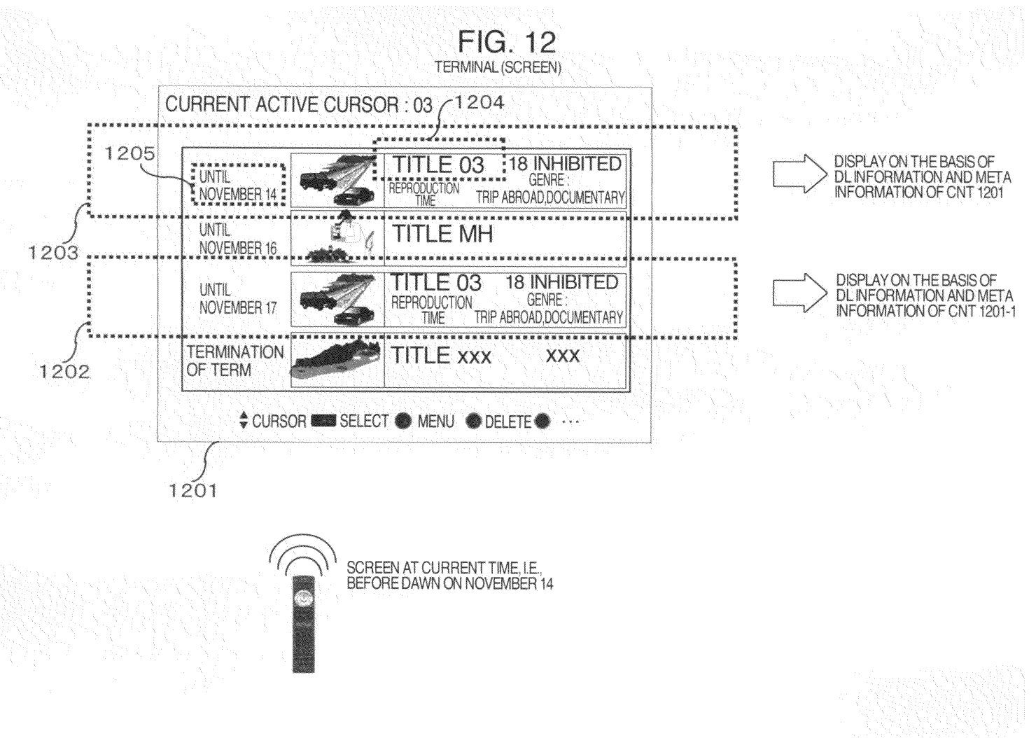

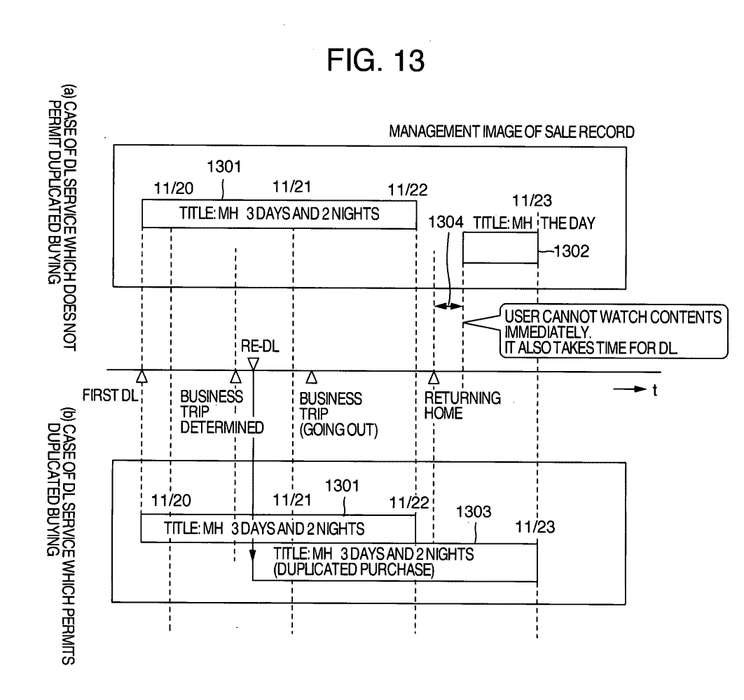

FIG. 12 shows an example of a screen of the user terminal 105 displayed when duplicated buying is conducted. With respect to contents which are the same 03 in title 1204, purchased information 1202 and 1203 are displayed on a screen 1201. It becomes possible for the user to select preferred one from information 1203 first purchased and information 1202 subjected to duplicated buying with respect to the same contents and execute the contents.

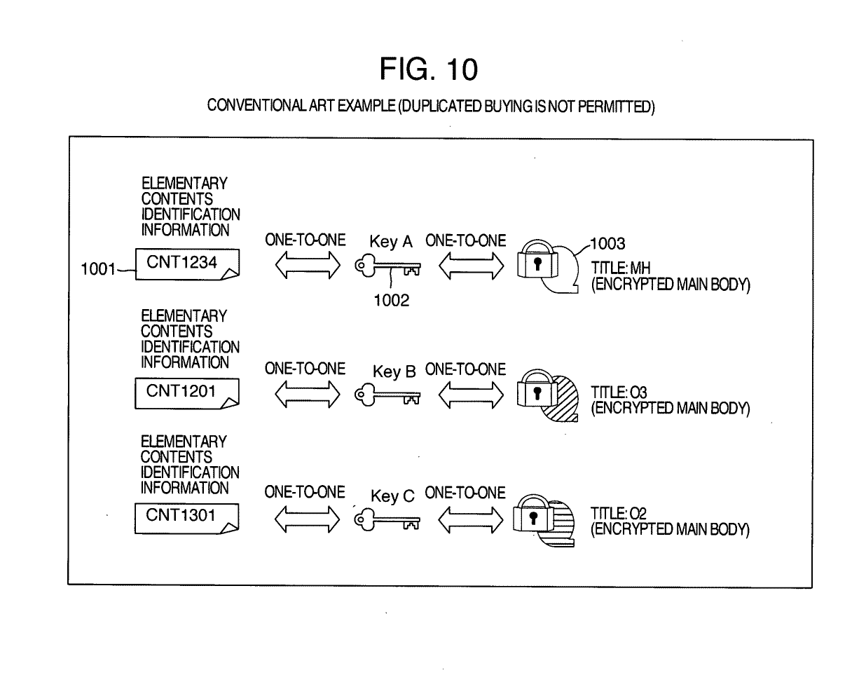

In the conventional DL service, the user ID, the sale date and the watching or listening time period are managed in one body as the elementary contents identification information 1001 by using the contents ID as described in BACKGROUND OF THE INVENTION with reference to FIG. 10. While a certain user is utilizing the DL service with respect to certain contents (over a watching or listening time period), therefore, the user cannot download the contents again.

A method for providing DL service permitting duplicated buying relatively simply includes the steps of preparing a plurality of encryption keys with respect to the same contents with duplicated buying taken into consideration beforehand, encrypting contents with the encryption keys beforehand, and managing as many contents main bodies (already encrypted) as the number N of the encryption keys in a contents management server or the like. As a result, a plurality of prepared duplicated buying becomes possible. In this method, however, the following important problems are caused.

(1) Since the same contents are encrypted by using a plurality of encryption keys a plurality of times, acceptance work in preparing contents remarkably increases, resulting in a poor work efficiency.

(2) Since it is necessary to prepare all contents by the number of a plurality of keys beforehand, the capacity of contents to be managed by the center increases to N times.

(3) Since the capacity managed by the center increases, the power dissipation is also high, resulting in a minus from the aspect of environment.

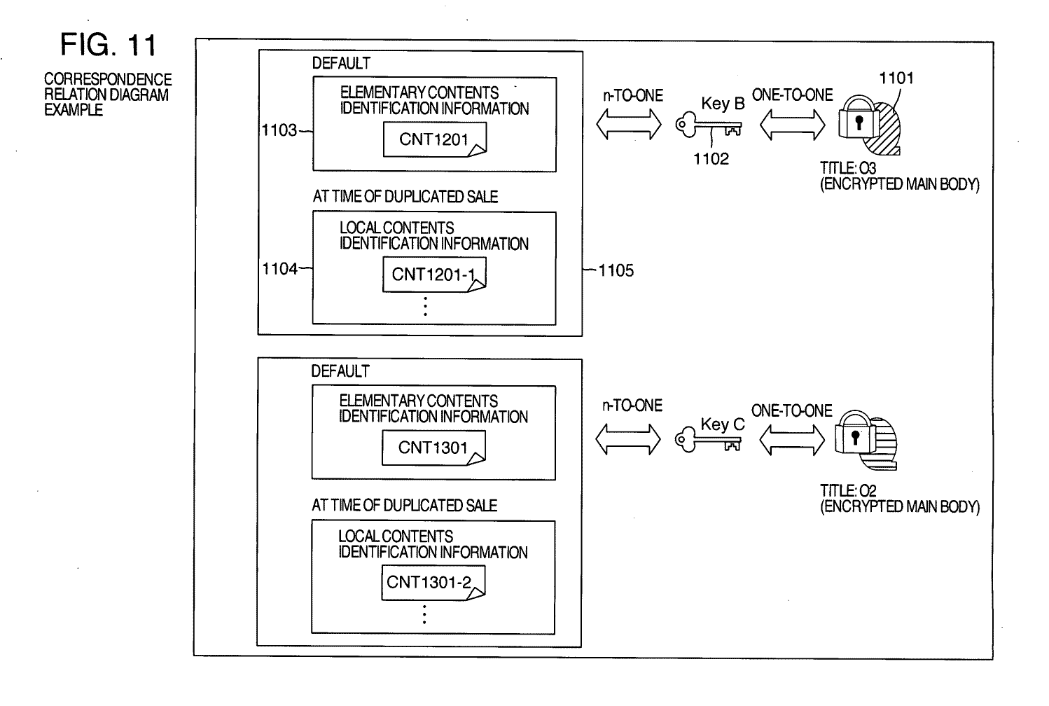

Relations in the DL service permitting duplicated buying according to the present embodiment between information used by the center system to provide and manage the DL service, which is mainly keys, and contents will now be described with reference to FIG. 11. In the present embodiment, contents 1101 themselves downloaded to the user terminal are encrypted by using an encryption key 1102. The contents 1101 and the encryption key 1102 are associated with each other in one-to-one correspondence. First, at the time of first DL for a certain user, DL service is provided by using elementary contents identification information which is default. In the case of re-DL of duplicated sale (duplicated buying), DL service is provided by using local contents identification information 1104. As a result, re-DL becomes possible with respect to the pair of the contents 1101 and the encryption key 1102. If a DL request is issued with respect to the same contents again, re-DL can be made possible by generating and using third local contents identification information 1104.

An identifier: contents ID of the local contents identification information 1104 is provided separately from an identifier: contents ID of the elementary contents identification information 1103. As a result, it becomes possible to identify the contents identification information used in the DL service. In communication between a terminal and the center in DL service, communication for DL service permitting duplicated buying is made possible by uniquely setting and using the identifier: contents ID of the elementary contents identification information 1103 and the identifier: contents ID of the local contents identification information 1104. In an example shown in FIG. 11, contents having a title O3 and contents having a title O2 are encrypted by using corresponding encryption keys Key B and Key C, respectively. Furthermore, the contents having the title O3 and contents having the title O2 are subjected to first DL by using a contents ID: CNT 1201 and a contents ID: CNT 1301, respectively. At the time of duplicated sale (duplicated buying), re-DL is conducted by using a contents ID: CNT 1201-1 and a contents ID: CNT 1301-2, respectively.

In the present embodiment, the contents main body 1101 and the encryption key 1102 are associated with each other in one-to-one correspondence as shown in FIG. 11 in the same way as the conventional art example shown in FIG. 10. As for the contents ID, however, contents ID 1104 for duplicated sale is generated newly in addition to the original contents ID 1103. DL information and meta information are generated for every new contents ID. In a resultant configuration, a plurality contents IDs can share the contents main body 1101 and the encryption key 1102. It is not necessary to duplicate the combination of the contents main body 1101 and the encryption key 1102 wastefully.

It should be further understood by those skilled in the art that although the foregoing description has been made on embodiments of the invention, the invention is not limited thereto and various changes and modifications may be made without departing from the spirit of the invention and the scope of the appended claims.

1. A contents management system for causing contents specified by a user to be downloaded to a user in response to a request from the user, the contents management system comprising:
a sale acceptance unit for receiving a contents purchase request which specifies contents by using a first contents ID, from the user; and
a sale management unit for judging whether contents which are a subject of the purchase request of the user are contents which are already purchased by the user and which can be executed by the user, and responding to judgment that the contents can be executed by the user, by generating a second contents ID and a one-time URL which is a place to be accessed by the user to specify the contents with the second contents ID and download the contents,
wherein the sale acceptance unit transmits the second contents ID and the one-time URL received from the sale management unit to a terminal of the user.

2. The contents management system according to claim 1, further comprising:
a download information provision unit for receiving the second contents ID and the one-time URL from the sale management unit and generating download information which corresponds to the second contents ID and which is required to download the contents,
wherein when the user accesses by using the one-time URL, the download information provision unit provides the user with the download information.

3. The contents management system according to claim 2, wherein
the download information includes contents provision place information to be accessed by the user to download the contents, and
the contents management system further comprises a delivery unit to deliver contents to the user when the user accesses by using the contents provision place information.

4. The contents management system according to claim 2, wherein
the download information includes license provision place information to be accessed by the user to obtain a license for executing the contents, and
the contents management system further comprises a license request acceptance unit to provide the user with a license when the user accesses by using the license provision place information.

5. The contents management system according to claim 2, wherein
the sale management unit generates meta information which corresponds to the second contents ID and which accompanies the contents, as well,
the download information includes meta information provision place information to be accessed by the user to acquire the meta information, and
the download information provision unit provides the user with the meta information when the user accesses by using the meta information provision place information.

6. The contents management system according to claim 1, further comprising:
a storage unit for retaining sale information which includes a contents ID of contents purchased by the user and information representing whether the contents can be executed,
wherein the sale management unit judges whether to generate the second contents ID and the one-time URL for the contents, by referring to the sale information in the storage unit.

7. The contents management system according to claim 1, wherein
before transmitting the second contents ID and the one-time URL, the user is notified that the user is about to conduct duplicated buying of the same contents.
